(19) United States
(12) Patent Application Publication
(10) Pub. No.: US 2018/0246824 A1
(43) Pub. Date: Aug. 30, 2018

(54) SYSTEM PROVIDED WITH COMPUTER AND STORAGE APPARATUS AND METHOD FOR CONTROL OF SYSTEM

(71) Applicant: HITACHI, LTD., Tokyo (JP)

(72) Inventors: Aritoki TAKADA, Tokyo (JP); Toshiyuki ARITSUKA, Tokyo (JP); Shinichi HAYASHI, Tokyo (JP)

(73) Assignee: HITACHI, LTD., Tokyo (JP)

(21) Appl. No.: 15/754,891

(22) PCT Filed: Dec. 9, 2015
(86) PCT No.: PCT/JP2015/084460

§ 371 Date: Feb. 23, 2018

(51) Int. Cl. G06F 13/20; G06F 9/50

(52) U.S. Cl. CPC G06F 13/20; G06F 2213/0026; G06F 9/5027

(57) ABSTRACT

A system including a computer provided with a memory configured to store a program and a first CPU (central processing unit) configured to execute the program and a storage apparatus provided with a drive coupled to the computer to store data and a second CPU configured to control storage of data in the drive according to an IO request issued by the program. The first CPU transmits an IO proposed plan which is information on the IO request to be issued by the program to the storage apparatus. The second CPU determines to adopt the IO proposed plan based on a resource utilization rate of the storage apparatus when the process of the IO request to be issued is executed and transmits a notification indicating the adopted IO proposed plan to the computer. The first CPU issues an IO request relating to the IO proposed plan based on the notification.

### TECHNICAL FIELD

The present invention relates to a system provided with a computer and a storage apparatus and a method for control of the system.

### BACKGROUND ART

Computer system is normally constructed of one or a plurality of computers that process data and one or a plurality of storage apparatuses that store data. The storage apparatus is shared among the plurality of computers and data necessary to data processing is read or written any time from/to each computer. Therefore, in order to achieve full processing performance in data processing by the computer, full performance is required not only for the computer but also for the storage apparatus. Furthermore, a sufficient communication bandwidth is required for a connection between the computer and the storage apparatus.

To achieve such performance, there is a method of reserving sufficient resources and securing performance by mounting high performance and a sufficient number of hardware devices on the storage apparatus or communication means between the computer and the storage apparatus. However, this method leads to increased cost of investment in the hardware.

PTL 1 discloses a technique in which a computer transmits information on an IO (input/output) request to be issued in the future such as a date and time on which the IO request is issued and data or data area or the like which becomes an IO request target as a “hint” to a storage apparatus in advance and the storage apparatus changes, in preparation for the IO request described in the “hint,” a data arrangement in the storage apparatus and arranges the target data in a high performance device when an IO request occurred so as to ensure performance while efficiently using resources in the storage apparatus.

### CITATION LIST

### Patent Literature

### [PTL 1]

U.S. Pat. No. 8,381,213

### SUMMARY OF INVENTION

### Technical Problem

According to PTL 1, an IO request occurred on a date and time unilaterally designated by a computer, and therefore if IO requests from a plurality of computers simultaneously occurred, there may be a shortage of high performance devices to be assigned to the respective IO requests, which may cause resource contention in which a plurality of computers overlappingly request reservation of resources. There can also be resource contention between internal processing and IO processing of the storage apparatus. In such a case, there is a problem that sufficient performance cannot be obtained in the storage apparatus and performance of a whole computer system deteriorates. It is therefore an object of the present invention to avoid resource contention without increasing hardware investment cost, ensure performance of a storage apparatus and thereby improve data processing performance of a computer or a whole computer system.

### Solution to Problem

A system comprises a computer including a memory configured to store a program and a first CPU (central processing unit) configured to execute the program and a storage apparatus coupled to the computer including a drive configured to store data and a second CPU configured to control storage of data in the drive according to an IO request issued by the program. The first CPU transmits an IO proposed plan which is information on the IO request to be issued by the program to the storage apparatus. The second CPU determines to adopt the IO proposed plan based on a resource utilization rate of the storage apparatus when the process of the IO request to be issued is executed and transmits a notification indicating the adopted IO proposed plan to the computer. The first CPU issues an IO request associated with the IO proposed plan based on the notification.

### Advantageous Effects of Invention

The present invention avoids resource contention without increasing hardware investment cost, ensures performance of a storage apparatus, and can thereby improve data processing performance of a computer or a whole computer system.

### BRIEF DESCRIPTION OF DRAWINGS

FIG. 1 is a diagram illustrating an example of a computer system;

FIG. 2 is a diagram illustrating an example of operation of an application;

FIG. 3 is a diagram illustrating an example of a processing sequence;

FIG. 4 is a diagram illustrating an example of a process plan function;

FIG. 5 is a diagram illustrating an example of application metrics;

FIG. 6 is a diagram illustrating an example of environment information;

FIG. 7 is a diagram illustrating an example of operation information;

FIG. 8 is a diagram illustrating an example of a proposed plan table;

FIG. 9 is a diagram illustrating an example of an IO proposed plan list;

FIG. 10 is a diagram illustrating an example of an operation flow of a plan creation function;

FIG. 11 is a diagram illustrating an example of an IO arbitration function;

FIG. 12 is a diagram illustrating an example of a plan store;

FIG. 13 is a diagram illustrating an example of a resource correspondence table;

FIG. 14 is a diagram illustrating an example of a resource performance table;

FIG. 15 is a diagram illustrating an example of a resource allocation time line;

FIG. 16 is a diagram illustrating an example of a reserved resource table;

FIG. 17 is a diagram illustrating a flow example of an IO plan reconfiguration function;

FIG. 18 is a diagram illustrating an example of an IO plan establishment function;

FIG. 19 is a diagram illustrating an example of an operation instruction function;

FIG. 20 is a diagram illustrating an example of a computer system including a plurality of storage apparatuses and a storage management server; and

FIG. 21 is a diagram illustrating an example of a display of an arbitration content display function.

### DESCRIPTION OF EMBODIMENTS

Hereinafter, an embodiment of the present invention will be described with reference to the accompanying drawings. However, the present embodiment is merely an example for implementing the invention and is not intended to limit the technical scope of the invention. Common components among the drawings are assigned the same reference numerals.

Note that in the following description, information of the present invention will be described using an expression “table,” but such information need not necessarily be expressed by a data structure using a table, and may be expressed by a data structure such as “list,” “DB (database),” “queue” and other data structures. Therefore, to demonstrate that the information is not dependent on a data structure, “table,” “list,” “DB,” “queue” or the like can also be simply called “information.” Furthermore, expressions such as “identification information,” “identifier,” “name” and “ID” can be used to describe contents of each piece of information and these are mutually substitutable.

A reading/writing process may be described as a read/write process or update process.

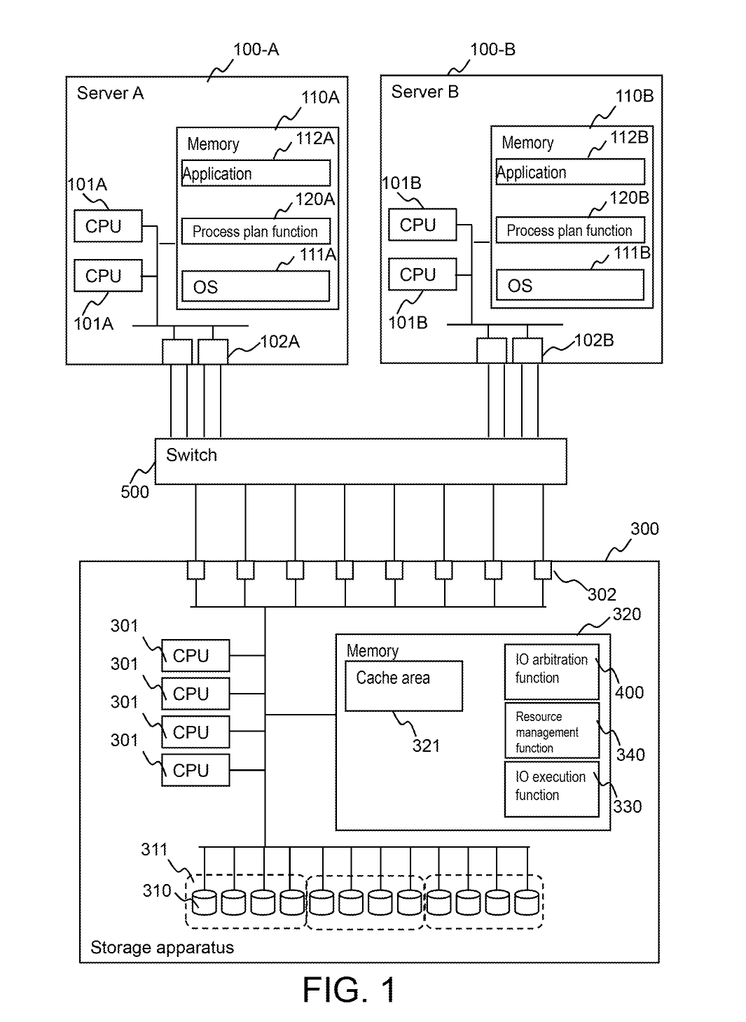

An embodiment of the present invention will be described using FIG. 1 to FIG. 21.

FIG. 1 is a diagram illustrating an example of a computer system to which the present invention is applied. The computer system includes one or a plurality of application servers (hereinafter, servers) 100 that process data and one or a plurality of storage apparatuses (hereinafter, storages) 300 that store data. As the servers 100, a server 100A and a server 100B are illustrated in the drawing, and to make the description easier to understand, the reference numeral of the element of the server 100A is a combination of a parent number and a child reference character “A” and the reference symbols of the element of the server 100B is a combination of a parent number and a child reference character “B.” When the server 100A and the server 100B need not be distinguished from each other, the reference symbols may be represented by parent numbers only.

The servers 100 and the storages 300 are coupled via fibre channels. These may be coupled directly or via a switch 500 or may be coupled using coupling means other than fibre channels, for example, PCIe (PCI express) coupling or the like or by combining a plurality of coupling means.

Regarding the server 100 and the storage 300, a case will be described hereinafter where main functions constituting the present invention are a program stored in a memory 110 and a CPU which is a main body that executes the program, and all or some of the functions may be implemented as other forms such as dedicated hardware such as an electronic circuit. Hereinafter, the above-described program will be called a “function” and that the CPU operates according to the program will be expressed as that the function operates. Furthermore, description will be given hereinafter assuming the “function” as the subject, but the “program” or “CPU” may be the subject. Various programs may be installed in each server 100 or storage 300 by a program delivery server or a storage medium.

The server 100 includes one or more CPUs 101 which are main bodies that execute the program, a memory 110 that stores programs or data and a host-bus adapter 102 coupled to the storage 300 via the switch 500 or the like. The memory 110 is constructed of a volatile memory such as a DRAM (dynamic random access memory), non-volatile memory or the like and stores an operating system (OS) 111, an application program (hereinafter, denoted as application or AP) 112 or in addition, a process plan function 120 which is a server internal function that constitutes an IO arbitration scheme in the present invention.

The CPU 101 executes an OS 111 and allocation 112 stored in the memory 110, or processes defined in the process plan function 120. The CPU 101 also executes transmission/reception of an IO request and write/read of data to/from the storage 300 along with the execution of processes.

The host-bus adapter 102 is an interface apparatus with the storage apparatus 300 and is assigned an identifier which is uniquely identifiable within a network such as WWN (world-wide name). The CPU 101 transmits/receives IO requests or the like via the host-bus adapter 102.

Note that the server 100 may be a host computer such as a workstation, personal computer or main frame. The server 100 is not limited to a physical server but may be a virtual server implemented under an LPAR (logical partition) scheme or VM (virtual machine) scheme.

The storage 300 includes one or more CPUs 301 which are main bodies that execute a program, one or more drives 310 which are main bodies that store data, a memory 320 and ports 302 coupled to the server 100 via the switch 500 or the like.

The drive 310 is constructed of, for example, an HDD (hard disk drive) or an SSD (solid state drive). The one or more drives 310 constitute a drive group 311 and provide, for example, a storage area integrated under, for example, a RAID (redundant arrays of inexpensive (independent) disks) scheme. One or a plurality of volumes which are IO destinations of the server 100 are created from this storage area and the volumes are provided to the server 100. Each volume is assigned a unique identifier UUID (universal unique identifier). Each volume is used for applications such as a data volume to record processed data of the server 100 or as a log volume to record a process of the server 100.

The memory 320 is constructed of a volatile memory such as a DRAM, a volatile memory or the like. The memory 320 includes a cache area 321 that temporarily stores data included in a write request received from the server 100 via the ports 302 or data requested to be read from the server 100. Furthermore, the memory 320 includes an IO execution function 330 that interprets and executes an IO request from the server 100 and a resource management function 340 that manages an amount and ratio of resources used by the IO execution function 330 and restricts use of resources by the IO execution function 330 based on a condition. Furthermore, the memory 320 includes an IO arbitration function 400 which is a main element under an IO arbitration scheme in the present invention.

The CPU 301 executes processing according to the definition of the program stored in the memory 320.

The port 302 is an interface apparatus for coupling to the server 100 and is assigned an identifier which is uniquely identifiable within a network such as WWN.

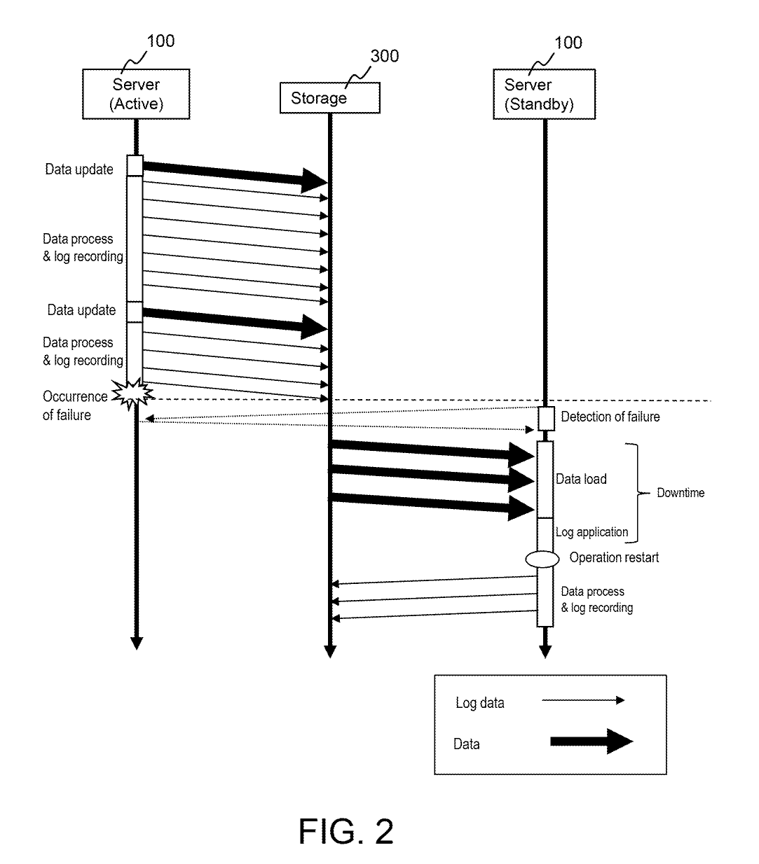

FIG. 2 is a sequence diagram illustrating a data flow associated with operation of the application 112. Before describing an overview of the present embodiment, operation of the application preferred in the present embodiment will be described first. However, the present embodiment is not limited to the application operating in this way, but is applied to a wide variety of applications.

The server 100 performs various types of data processes such as a transaction process and also successively transmits contents of the data process to the storage 300 as a log (thin line arrow), and records the log in a log volume of the storage apparatus 300. Furthermore, the server 100 collectively transmits update data generated as a result of the data processes to the data volume of the storage 300 (thick line arrow). The transmitted data is recorded as a snapshot in the storage 300. Here, the snapshot refers to data which is extracted from data such as a database file in operation and is recorded at specific timing. Hereinafter, a process of writing the update data and recording data at specific timing into a data volume may also be called a snapshot.

Note that the update data normally has a greater amount of data than log data, but is less frequently transmitted to the storage. The greater the interval of transmission of the update data is, the greater the amount of data updated becomes, and the amount of data transmitted to the storage 300 in one write of update data also tends to increase.

Next, a failure recovering method will be described in the case where the application 112 adopts a redundant configuration under a one-to-one or n-to 1 active-standby scheme and a failure occurs in the server 100 in active operation while the application 112 is being executed.

When a failure occurs in the server 100 in active operation, the server 100 in standby operation detects the failure and starts to take over the operation of the application 112. Upon detecting the failure, the server 100 in standby operation reads a snapshot and log in the storage 300 (data load, thick line arrow). Data of the read snapshot is data at a time point at which data is updated last time and does not reflect results of processes performed thereafter. Therefore, based on a record of the read log, data processes generated after the creation of the read snapshot are applied to the data of the snapshot (log application). Thus, the data relating to the application 112 of the server 100 in standby operation is returned to a state of the server 100 in active operation immediately before the occurrence of the failure, takeover of the operation is completed and the server 100 that takes over the process can resume a normal data process operation.

In this way, even when the snapshot is not successively updated, logs are successively recorded, and so by applying the processes recorded in the logs to the read snapshot, it is possible to restore the data of the server 100 to the state immediately before the failure.

Now, in the present embodiment, a specific method will be described which prevents resource contention of the storage 300 among the plurality of servers 100 by arbitrating timing and an interval of snapshot recordings among the plurality of servers 100.

A downtime is generated for a period of time after a failure occurs, until application of process contents recorded in a log is completed and the operation is resumed. The downtime is roughly divided into a time required to load data from the storage 300 and a time required to apply a log, and varies depending on a bandwidth between the server 100 and the storage 300 and the number of logs applied. The number of logs applied increases as the interval after recording of an immediately preceding snapshot until the occurrence of a failure becomes longer. The downtime may include a time from the occurrence of a failure until data load starts, but description in the present embodiment will not include the time from the occurrence of a failure until data load starts for simplicity.

Regarding this downtime, a case will be also described where the time necessary to load data or apply log contents is shortened and arbitration is performed so as to satisfy an SLO (service level objective) which is a target value of a service.

With an increase in storage capacity of server memory in recent years, there is increasing interest in an in-memory process in which when executing software such as an in-memory database, all the program and data used are read into a server memory and data is processed without using any external storage apparatus such as a storage apparatus. The reading/writing speed differs by some digits between the memory and the external storage apparatus, and since all the data is arranged in the memory in advance and executed in the in-memory, the in-memory has a merit that a process can be executed extremely fast. In such an in-memory process, while logs are written successively into the external storage apparatus, necessary data is in the server memory, and therefore update data is written to the storage apparatus in the in-memory process in order to protect the data, and even when writing timing is shifted, there is no significant influence on the execution of the in-memory process. For this reason, the present embodiment is suitable for use in a server executing an in-memory process as well as a computer system including the server.

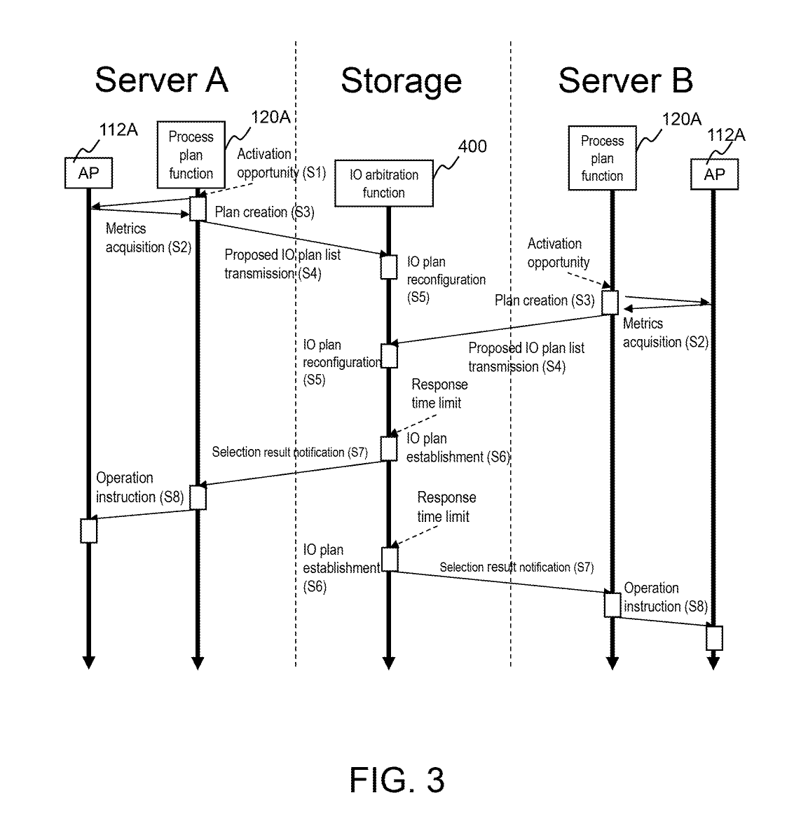

FIG. 3 is an example of a sequence diagram illustrating an overall flow of a process according to the present embodiment that controls operation of the application 112 by means of coordination between the process plan function 120 and the IO arbitration function 400. An overview of the present embodiment will be described using FIG. 3.

The process plan function 120 starts operation of plan proposal at an activation opportunity such as arrival of a snap acquisition period and an IO issuance request to the storage 300 first (S1). The process plan function 120 acquires an application metrics 200 which is information on an operation situation of the application 112 from the application 112 (S2), and creates a plurality of patterns of an IO plan issued by the application 112 based on the acquired application metrics (hereinafter simply referred to as “metrics”) 200. Here, the plurality of patterns include a pattern in which a snapshot is executed and a pattern in which no snapshot is executed. Furthermore, in the pattern in which no snapshot is executed, instead of not performing any snapshot, resources necessary to read data when a failure occurs are planned to be reserved so as to protect the downtime SLO in the event of a failure. The process plan function 120 creates an IO proposed plan list 210 which is a list of the plurality of proposed plans (S3) and transmits the IO proposed plan list 210 to the IO arbitration function 400 in the storage 300 (S4). Note that this IO proposed plan list 210 may include a response time limit.

The IO arbitration function 400 that receives the IO proposed plan list 210 (re)configures an IO plan which is an operation of reviewing the IO plan of selecting an IO plan from among the IO proposed plan list 210 received in the past and the newly received IO proposed plan list 210 (S5). The IO plan is selected one for each time from among a plurality of plans included in each IO proposed plan list 210 in consideration of the amount of resources used of the storage 300. Note that the transmission source process plan function 120 of the IO proposed plan list 210 may be notified of the selection result at a time point at which the IO plan is reconfigured, but the IO proposed plan selected along with the reconfiguration need not be immediately notified to the process plan function 120 at this time point in principle. After suspending the notification in preparation for arrival of a further IO proposed plan list 210, and consequently a further IO plan reconfiguration, the proposed plan is established along with arrival of a response time limit (S6) and the selection result is notified (S7). Upon receiving the notification of the selection result, the process plan function 120 instructs the application 112 to operate based on the contents (S8).

In consideration of the amount of resources used of the storage 300 for each time, the IO arbitration function 400 of the storage 300 selects an optimum IO proposed plan from the transmitted IO proposed plan list 210 and notifies the server 100 of the selected IO proposed plan, and can thereby avoid resource contention among the plurality of servers 100. After receiving the IO proposed plan list 210, the IO arbitration function 400 suspends the response until the response time limit is reached, and can thereby execute an IO plan reconfiguration process of selecting an optimum combination of IO proposed plans every time another IO proposed plan list is received and can arbitrate resource contention among the plurality of servers 100 more suitably. Furthermore, since a plurality of IO proposed plans are presented in consideration of the occurrence of a failure, even when an IO proposed plan which executes no snapshot is adopted, resources necessary to read data in the event of a failure are reserved, and so the downtime SLO can be protected even if a failure occurs.

Next, detailed processing according to the present embodiment will be described.

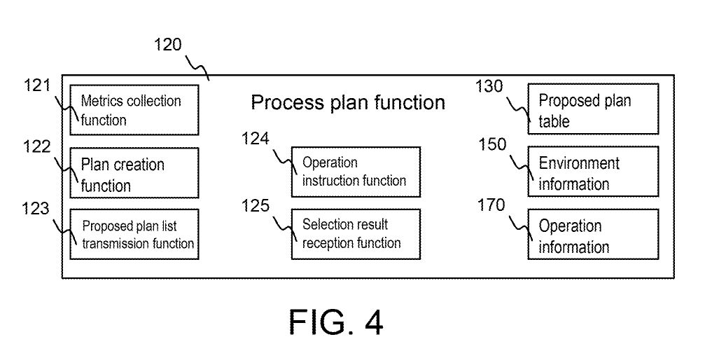

FIG. 4 is a diagram illustrating a configuration of the process plan function 120 that creates an IO plan and instructs operation of the application 112 based on the notified IO plan. The process plan function 120 includes a metrics collection function 121 that collects application metrics 200 which is information on an operation situation of the application 112, a plan creation function 122 that creates an operation plan based on the collected metrics or the like, a proposed list transmission function 123 that transmits an IO proposed plan list corresponding to the created plan to the storage 300, an operation instruction function 124 that instructs the application 112 on operation contents, a selection result reception function 125 that receives a selection result of an IO proposed plan from the storage 300, a proposed plan table 130 that stores the created proposed plan, environment information 150 which is information on a configuration of the server 100 or the storage 300, and operation information 170 which indicates information on a configuration relating to operation and operation contents of the application 112.

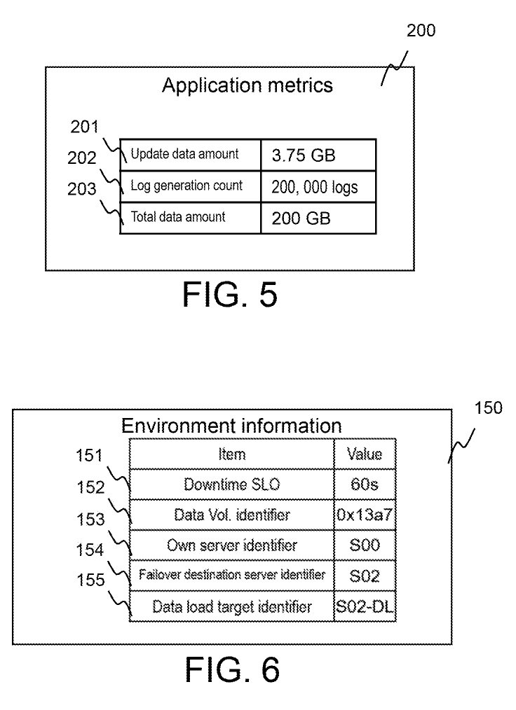

FIG. 5 is a diagram illustrating the application metrics 200 which is information on an operation situation of the application 112. The application metrics 200 includes information on an update data amount 201 after recording the last snapshot until acquiring the application metrics 200, a log generation count 202 for this period and a total data amount 203 recorded by the application 112 in the storage 300.

FIG. 6 is a diagram illustrating the environment information 150 which is information on the configuration of the server 100 or the storage 300 associated with the application 112. The environment information 150 includes a downtime SLO 151, a Data Vol. identifier 152, an own server identifier 153, a Failover destination server identifier 154 and a data load target identifier 155. The downtime SLO 151 is a target value of a time required after a failure occurs or after data load for recovery from the failure starts until recovery from the failure. The Data Vol. identifier 152 indicates a volume in the storage 300 used by the application 112 and stores an identifier for identifying a volume such as UUID. The application 112 writes update data into the volume identified by the Data Vol. identifier 152.

The own server identifier 153 stores an identifier of the server 100 that executes the application 112. The Failover destination server identifier 154 stores an identifier of the server 100 at the failover destination that takes over the execution of the application 112 when a failure occurs in the server 100 which is executing the application 112. As the identifier of the server 100, for example, a World Wide Name of the host side host-bus adapter 102 and a name used by the storage 300 to identify this are used.

The data load target identifier 155 stores an identifier indicating a data IO target. “S02-DL” indicates that data load along with a failover is the target.

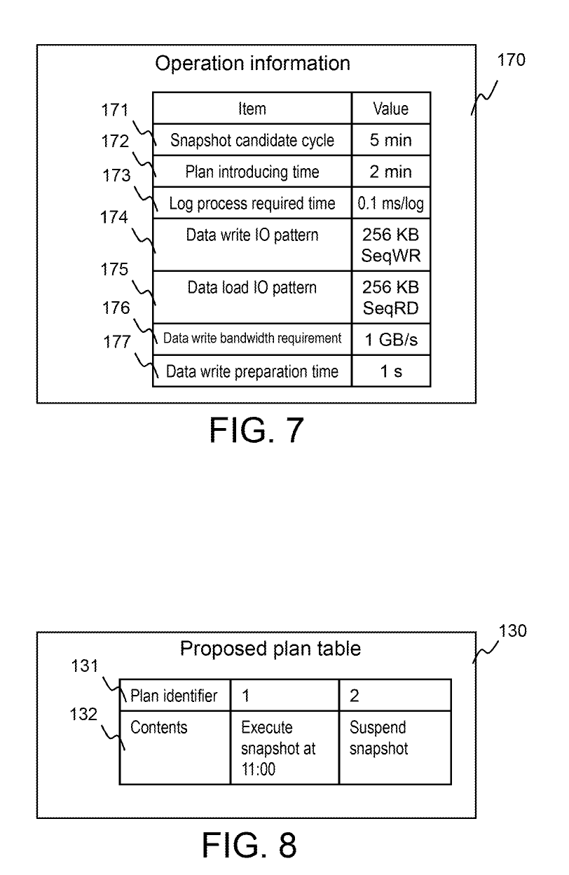

FIG. 7 is a diagram illustrating the operation information 170 indicating information on a configuration relating to operation and operation contents of the application 112. The operation information 170 includes a snapshot candidate cycle 171, a plan introducing time 172, a log process required time 173, a data write IO pattern 174, a data load IO pattern 175, a data write bandwidth requirement 176 and a data write preparation time 177.

The snapshot candidate cycle 171 represents a cycle or time point at which the application 112 updates a snapshot in the storage 300, that is, a cycle or time point at which the application transmits update data to the storage 300. For example, it is possible to configure the snapshot candidate cycle 171 so that a snapshot is updated every five minutes or a snapshot is updated five minutes after every hour.

In the present embodiment, before issuing IO to the storage 300 to update a snapshot or the like, a plurality of proposed plans are transmitted to the IO arbitration function 400 and IO is executed according to the proposed plan notified from the IO arbitration function 400. Therefore, a proposed plan needs to be transmitted to the IO arbitration function 400 before the application 112 updates the snapshot. Thus, the plan introducing time 172 indicates approximately how much time before the snapshot update timing the plan is created and transmitted to the IO arbitration function 400. For example, in the example in FIG. 7, the time is configured to be 2 minutes and the plan creation starts 2 minutes before the snapshot update cycle or the arrival of the time point. Furthermore, a cycle in which the IO proposed plan is created may be recorded in the plan introducing time 172. When the cycle in which the IO proposed plan is created is recorded in the plan introducing time 172, the IO proposed plan may be created in the recorded cycle and the IO proposed plan list 210 may be transmitted to the storage 300 or only when a proposed plan of suspending the snapshot is adopted, an IO proposed plan may be then created in a defined cycle or the IO proposed plan list 210 may be transmitted until execution of the snapshot is selected.

The log process required time 173 represents the time required to apply a log to the data loaded from the storage 300 after a failure occurs and is used to calculate a downtime.

The data write IO pattern 174 represents an IO pattern when the application 112 writes data to the storage 300 to update a snapshot or the like. The example in FIG. 7 shows a sequential write, a data transfer unit of which is 256 KB. The data write IO pattern 174 is configured because necessary resources of the storage 300 vary depending on whether the IO is sequential or random. The data load IO pattern 175 represents an IO pattern when data is loaded from the storage 300 after a failure occurs. The example in FIG. 7 shows a sequential read, a data transfer unit of which is 256 KB. Information on a typical IO length or its access order known beforehand in addition to a read/write type is described in the data write IO pattern 174 and the data load IO pattern 175.

The data write bandwidth requirement 176 indicates a necessary bandwidth when data is written to the storage 300. The data write preparation time 177 is a time required after a proposed plan selection result is notified from the IO arbitration function 400 until a data write process starts. The data write preparation time 177 is used to calculate a response time limit.

FIG. 8 is a diagram illustrating a proposed plan table 130 in which an operation proposed plan at certain timing is stored. The operation proposed plan refers to executing or suspending a snapshot at certain snapshot candidate timing. The proposed plan table 130 records a plan identifier 131 of an operation proposed plan and contents 132 of the operation proposed plan.

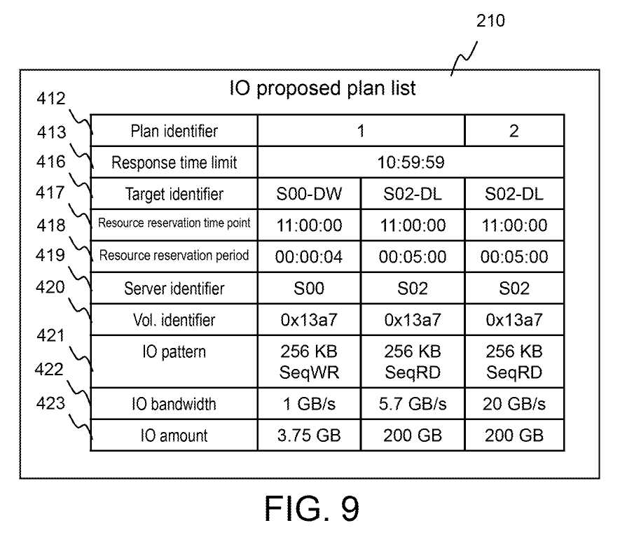

FIG. 9 is a diagram illustrating a IO proposed plan list 210 in which contents of an IO request generated when each operation plan is adopted or IO performance is recorded to execute the operation proposed plan of the proposed plan table 130. The IO proposed plan list 210 includes a plurality of IO proposed plans corresponding to each operation proposed plan. The IO proposed plan list 210 includes a plan identifier 412, a response time limit 413, a target identifier 416, a resource reservation time point 417, a resource reservation period 418, a server identifier 419, a Vol. identifier 420, an IO pattern 421, an IO bandwidth 422 and an IO amount 423.

The plan identifier 412 corresponds to the plan identifier 131 of the proposed plan table 130. The response time limit 413 is a time limit within which a notification of a selection result of a proposed plan from the IO arbitration function 400 is requested and is calculated from the snapshot candidate cycle 171 and the data write preparation time 177. For example, according to the snapshot candidate cycle 171, if the next snapshot update time point is 11 h 00 m, 00 s, since one second is necessary to prepare for data write after receiving a notification, the response time limit 413 becomes 10 h 59 m 59 s.

The target identifier 416 stores an identifier indicating a data IO target. When a reconfiguration plan creation function 402, which will be described later, needs a necessary performance integration process for each target, an identifier indicating the target is described. For example, “S00-DW” indicates that data write for a snapshot update is a target and “S02-DL” indicates that data load accompanying a failover is a target. The target identifier 416 is described in advance in the data load target identifier 155 in the environment information 150.

Regarding IO contents or necessary IO performance from the target identifier 416 onward, in the case of the operation proposed plan 1, for updating the snapshot the IO performance or the like necessary to write data accompanying the snapshot update and the IO performance or the like necessary to load data when a failure occurs are calculated and described. On the other hand, in the case of the operation proposed plan 2, for suspending the snapshot update, the IO performance or the like necessary to load data when a failure occurs for a time period until the next snapshot update, is calculated and described. Since the time required for log application after the occurrence of a failure varies when the snapshot is updated and when the snapshot update is suspended, it is necessary to adjust the data load time to satisfy the downtime SLO 151 and the necessary IO bandwidth varies.

The resource reservation time point 417 indicates a time point at which reservation of resources of the storage 300 starts. Furthermore, the resource reservation period 418 indicates a time period during which the resources continue to be reserved after reservation of the resources starts. For the server identifier 419, the own server identifier 153 in the environment information 150 is used for a snapshot and the identifier described in the failover destination server identifier 154 which is a data load execution source is used for data load. For the Vol. identifier 418, the identifier described in the Data Vol. identifier 152 in the environment information 150 is used. As for the IO pattern 421, the data write IO pattern 174 of the operation information 170 is described when the target identifier 416 is “S00-DW” and the data load IO pattern 175 is described when the target identifier 416 is “S02-DL.”

The IO bandwidth 422 indicates an IO bandwidth necessary to execute IO and the IO amount 423 indicates an amount of written/read data.

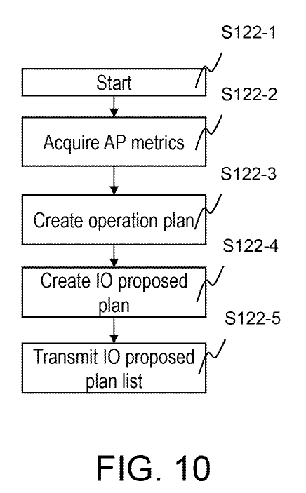

FIG. 10 is a diagram illustrating a flowchart in which the plan creation function 122 of the process plan function 120 creates a plan. This corresponds to detailed description of the plan creation (S3) in FIG. 3.

The plan creation function 122 starts operation at prescribed timing (S122-1). For example, when the snapshot candidate timing based on the snapshot candidate cycle 171 in the operation information 170 is configured to be 0 minutes, 5 minutes, IO minutes . . . after every hour, the operation start timing becomes 2 minutes before each snapshot candidate timing, that is, 58 minutes, 3 minutes, 8 minutes . . . after every hour and so forth from the plan introducing time 172.

Next, the plan creation function 122 calls the metrics collection function 121 and acquires the application metrics 200 (S122-2). The metrics collection function 121 accesses an information providing interface provided for the application 112 via an API call or socket communication for an application, for example, and acquires the application metrics 200.

Next, the plan creation function 122 creates an operation proposed plan and stores it in the operation plan table 130 (S122-3).

Next, as for each created operation proposed plan, the plan creation function 122 calculates contents of an IO request generated when each operation plan is adopted or necessary IO performance, creates an IO proposed plan of each operation plan to make a listed IO proposed plan list 210 (S122-4). The present embodiment will describe a method of creating the IO proposed plan list 210 from contents of the proposed plan table 130, contents of the application metrics 200 and contents of the environment information 150. For the plan identifier 412 in the IO proposed plan list 210, the plan identifier 131 of the proposed plan table 130 is used. For the response time limit 413, a result of subtracting the data write preparation time 177 from the snapshot candidate timing is used. From the target identifier onward, specific IO contents or necessary IO performance are as per the plan identifier 1, and when a snapshot process is executed, write contents for this and IO performance for data load caused by a failover are calculated and described, and when a snapshot process is not executed, IO performance for data load is calculated and described.

The resource reservation time point 417 and the resource reservation period 418 are calculated from the snapshot candidate timing, the next snapshot candidate timing (5 minutes later) for data load, and calculated from an IO bandwidth 422 and an IO amount 423, which will be described later, for write caused by the snapshot.

Here, the method of calculating the IO bandwidth 422 and the IO amount 423 will be described in detail. First, the IO bandwidth 422 and the IO amount 423 in the write caused by the snapshot update in the plan identifier 1 can be calculated from the update data amount 201 of the application metrics 200 and the data write bandwidth requirement 176 of the operation information 170. That is, the data write bandwidth requirement 176 is described in the IO bandwidth 422 and the update data amount 201 is described in the IO amount 423. Note that instead of describing the update data amount 201 directly in the IO amount 423, a value obtained from the update data amount 201 may be described. For example, when the snapshot candidate cycle 171 is a 5-minute interval and the plan introducing time 172 is 2 minutes, a data amount 2 minutes after the timing of the plan creation may be predicted and a value obtained by multiplying the IO amount by (5−2)/5 may be recorded.

Next, in an IO bandwidth 422 of data load with the plan identifiers 1 and 2, prior to a calculation, the plan creation function 122 calculates a time required to reapply the log based on the log generation count 202 in the application metrics 200, by calculating a log amount predicted to be generated by the next snapshot candidate timing when, for example, a snapshot process is performed and a log amount when no snapshot process is performed. In addition, the plan creation function 122 calculates a time required to reapply the log at the time of recovery from the failure in each case from the log process required time 173 in the operation information 170. For example, when the log generation count 202 from the last snapshot update is 200,000, since the snapshot candidate cycle 171 is 5 minutes and the plan introducing time 172 is 2 minutes, if no snapshot process is executed this time between snapshot updates, further 200,000 logs are predicted to be generated. Since the log process required time 173 is 0.1 ms/log, a time for log reapplication is calculated to be 20 seconds for the proposed plan 1 and 40 seconds for the proposed plan 2. Next, the log reapplication required time in each case is subtracted from the downtime SLO 151 in the environment information 150 and the result is assumed to be a maximum time assigned to data load. For example, when the SLO 151 is 60 seconds, the maximum time is calculated to be 40 seconds for the proposed plan 1 and 20 seconds for the proposed plan 2. The IO bandwidth 422 necessary in each case is calculated by dividing the total data amount 203 by this maximum time. The total data amount 203 in the application metrics 200 is described in the IO amount 423 of the data load.

The IO proposed plan list 210 is created in this way, and even when an IO proposed plan in which no snapshot is executed is adopted, resources necessary to read data in the event of a failure are reserved, and so the downtime SLO can be observed even if a failure occurs. That is, it is possible to achieve both observation of the downtime SLO and the resource efficiency. Moreover, presenting different kinds of workload (securing short-time data write and long-time data load bandwidth) as alternatives makes it possible to reduce imbalance in the utilization rate among resources of the storage 300 and achieve more efficient use of resources.

The number of IO proposed plans included in the IO proposed plan list 210 may be one. In this case, the IO arbitration function 400 selects whether or not to adopt the IO proposed plan included in the IO proposed plan list 210. A plurality of IO proposed plans included in the IO proposed plan list 210 may propose different timings of executing a snapshot. For example, three IO proposed plans may be included in the IO proposed plan list 210, which execute a snapshot at 11:00, 11:01 and 11:02 respectively. Either case may or may not be included in the IO proposed plan that reserves resources for loading data in the event of a failure.

The proposed plan list transmission function 123 transmits the created IO proposed plan list 210 to the IO arbitration function 400 in the storage 300 (S122-5). The proposed plan list transmission function 123 transmits the IO proposed plan list 210 to the storage 300 using any one of communication means such as network between the server 100 and the storage 300.

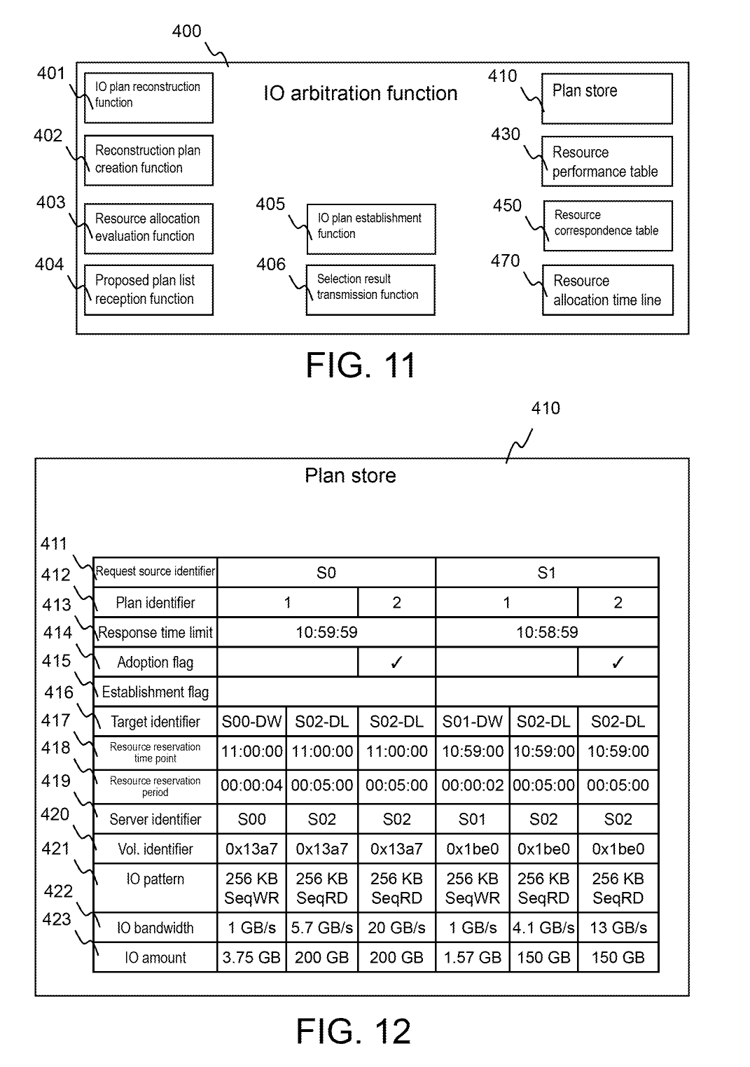

FIG. 11 illustrates a configuration of the IO arbitration function 400 that reconfigures an IO plan and selects/notifies the proposed plan. The IO arbitration function 400 is provided with an IO plan reconfiguration function 401 that updates the IO plan based on a new IO proposed plan list 210 received from the server 100. The IO arbitration function 400 is further provided with a reconfiguration plan creation function 402 used by the IO plan reconfiguration function 401 to create an update plan for the IO proposed plan, a resource allocation evaluation function 403 that evaluates the created reconfiguration plan from the standpoint of a resource utilization rate or the like, and a proposed plan list reception function 404 that receives the IO proposed plan list 210 from the server 100. When necessary, the IO arbitration function 400 is also provided with an IO plan establishment function 405 that establishes part or a whole of the IO plan and a selection result transmission function 406 that sends the established selection result as a reply to the server 100. The IO arbitration function 400 is further provided with a plan store 410 that stores an IO proposed plan received from the server 100, a resource performance table 430 to be used for IO plan reconfiguration and evaluation, a resource correspondence table 450, and a resource allocation time line 470 that shows a resource allocation schedule based on the current IO plan.

FIG. 12 is a diagram illustrating the proposed plan store 410 that stores the IO proposed plan list 210 received from the server 100. In the plan store 410, the received values of the IO proposed plan list 210 are stored as they are in a plan identifier 412, a response time limit 413, a target identifier 416, a resource reservation time point 417, a resource reservation period 418, a server identifier 419, the Vol. identifier 420, an IO pattern 421, an IO bandwidth 422 and an IO amount 423. An identifier indicating a transmission source of the IO proposed plan list 210, for example, an identifier of the server 100 is stored in a request source identifier 411. An adoption flag 414 is a flag indicating a proposed plan scheduled to be selected when no new IO proposed plan list 210 arrives hereafter and an establishment flag 415 is a flag indicating a proposed plan, a selection of which is established because its response time limit is reached.

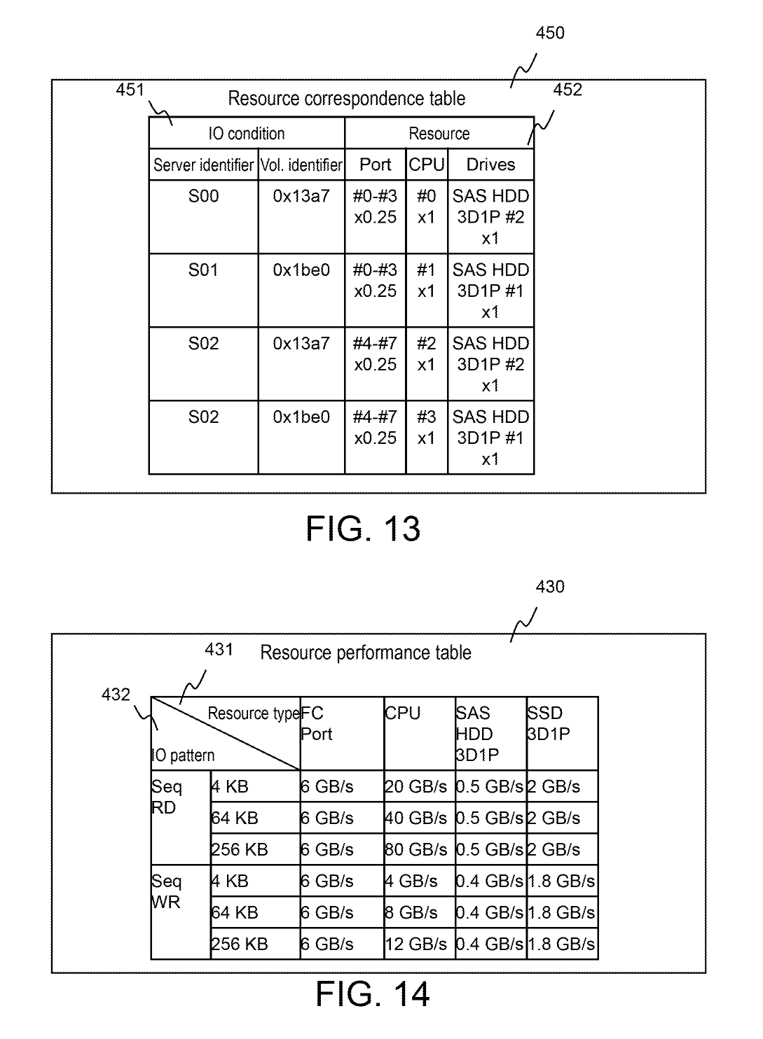

FIG. 13 is a diagram illustrating the resource correspondence table 450 showing a relationship between IO conditions and resources used. The resource correspondence table 450 identifies resources 452 of the storage 300 to be used under IO conditions 451 defined by the server 100 which is an IO issuance source and a volume which is an IO issuance destination.

For example, an IO directed from the server 100 with an identifier S0 to a volume with an identifier 0x13a7 is sent to the storage 300 via any one of ports with identifiers #0 to #3 respectively at a probability of 25%, processed by the CPU 301 with an identifier #0 and data thereof is written/read to/from the storage drive 310 with an identifier SAS HDD 3D1P #2. The resources here refer to hardware resources necessary for the storage 300 to execute processes such as IO process and internal process, and include, for example, times and areas of the CPU 301 and the memory 320, and a bandwidth of the port 302.

FIG. 14 is a diagram illustrating a resource performance table 430 showing resource performance necessary to process each IO pattern. In the resource performance table 430, a plurality of IO patterns 432 and a plurality of resource types 431 form a matrix, showing resources necessary to execute each IO pattern and necessary performance of the resources.

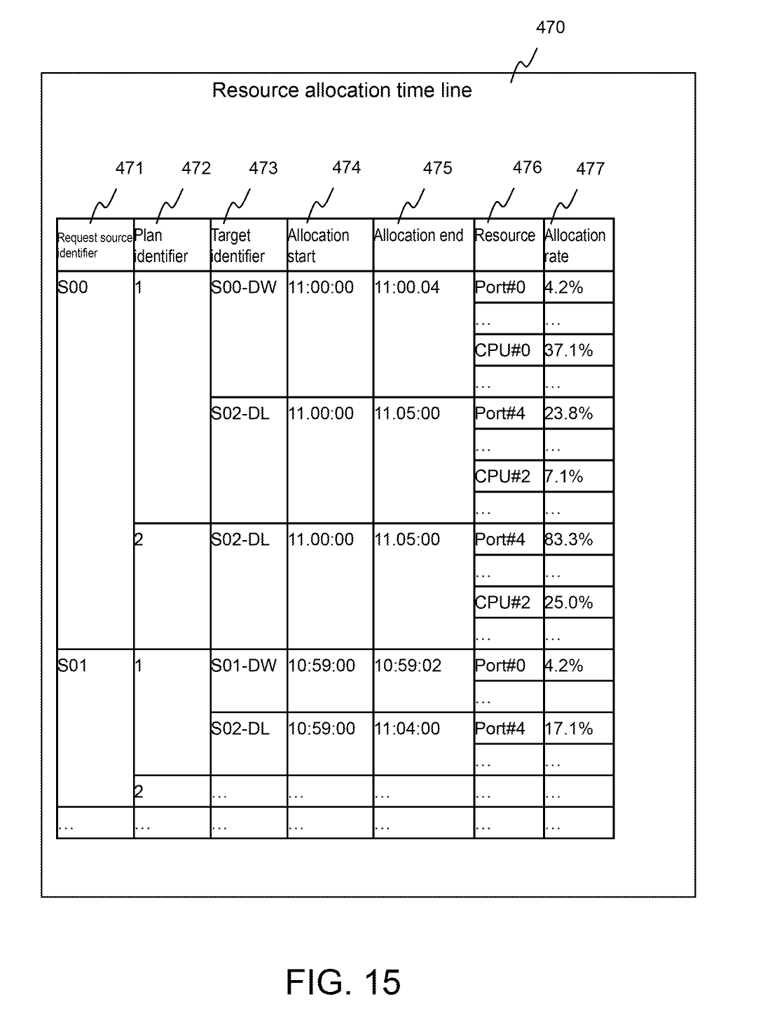

In adopting each IO proposed plan stored in the plan store 410, FIG. 15 is a table showing the resource allocation time line 470 indicating types, rates and allocation periods of resources necessary to be allocated to execute processes described in the IO proposed plan. A request source identifier 471, a plan identifier 472, a target identifier 473 and an allocation start time 474 store the request source identifier 411, the plan identifier 412, the target identifier 416 and the resource reservation time point 417 of the plan store 410 respectively. An allocation end time 475 stores a time point which is the sum of the resource reservation time point 417 and the resource reservation period 418. A resource 476 stores resources necessary to execute each process and an allocation rate 477 stores an allocation rate which is a rate of a resource necessary to be allocated to execute each process. For example, it is predicted that allocation of 37.1% of the CPU 301#0 is necessary to execute a process of S00-DW of the IO proposed plan 1 of the request source S00.

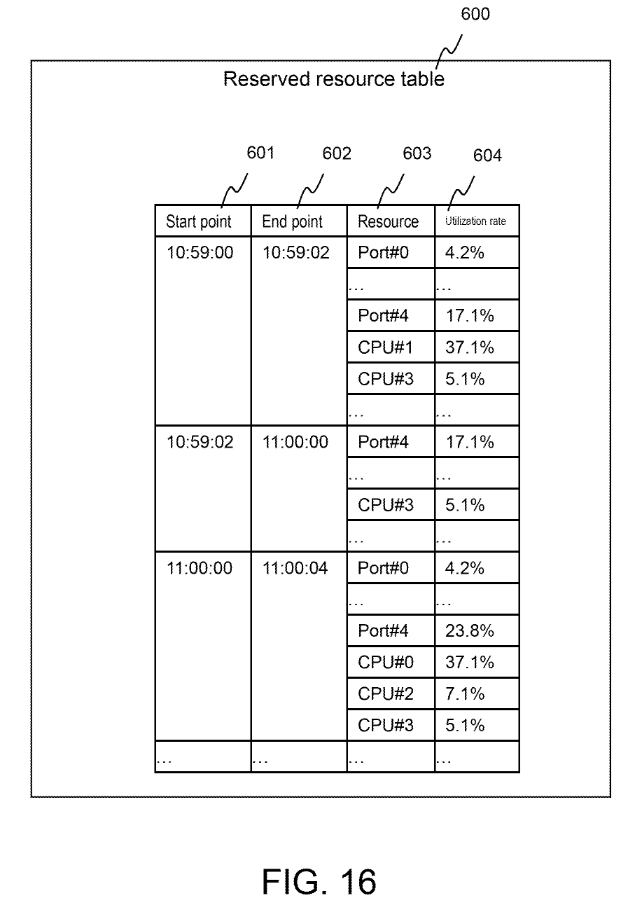

FIG. 16 is a diagram illustrating a reserved resource table 600 showing a resource of the storage 300 used when executing an IO proposed plan adopted or established in each time zone and a utilization rate of the resource. The reserved resource table 600 records a start point time point 601, an end point time point 602, a resource 603 used in the time zone and a utilization rate 604 which is a rate of the resource used in the time zone.

For example, a case will be described where the IO arbitration function 400 selects, from the resource allocation time line 470 in FIG. 15, the IO proposed plan 1 from the IO proposed plan list 210 from the request source S00 and selects the IO proposed plan 1 from the IO proposed plan list 210 from the request source S01. From 10 h 59 m 00 s to 10 h 59 m 02 s, the sum of a resource to write data from the server 100 of S01 in the proposed plan 1 of the request source S01 and a resource to load data to the server 100 of S02 is reserved, and from 10 h 59 m 02 s to 11 h 00 m 00 s, a resource to load data to the server 100 of S02 in the proposed plan 1 of the request source S01 is reserved. From 11 h 00 m 00 s to 11 h 00 m 04 s, the sum of a resource to load data to the server 100 of S02 in the proposed plan 1 of the request source S01, a resource to write data from the server 100 of S00 in the proposed plan 1 of the request source S00 and a resource to load data to the server 100 of S02 is reserved.

Note that the reserved resource table 600 may sum up not only resources of the storage 300 allocated to IO processes requested from the server 100 but also resources of the storage 300 allocated to internal processes of the storage 300 such as remote copy, in the utilization rate 604.

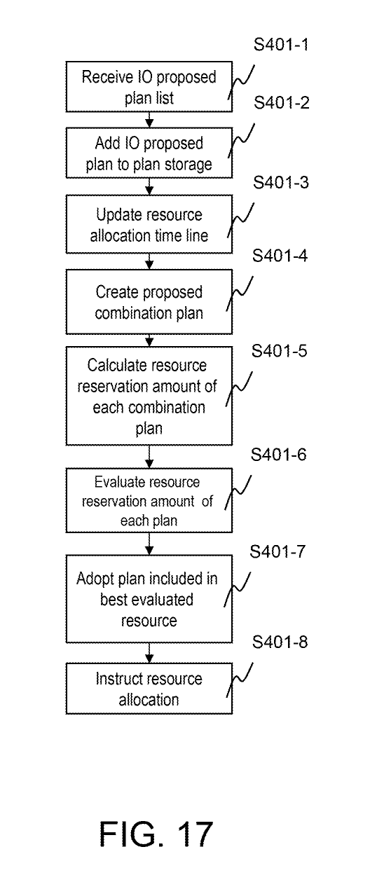

FIG. 17 is a diagram illustrating a flowchart of a process for the IO plan reconfiguration function 401 of the IO arbitration function 400 to reconfigure an IO plan. This is a detailed description of the IO plan reconfiguration (S5) in FIG. 3.

First, the IO plan reconfiguration function 401 receives the IO proposed plan list 210 using the proposed plan list reception function 404 and thereby starts operation (S401-1). Next, the IO plan reconfiguration function 401 adds contents of the received IO proposed plan list 210 to the plan store 410 (S401-2). The IO plan reconfiguration function 401 stores an identifier indicating the transmission source of the IO proposed plan list 210 in the request source identifier 411. The IO plan reconfiguration function 401 does not configure any flag in the adoption flag 414 and the establishment flag 415 at this time point yet.

Next, the IO plan reconfiguration function 401 updates the resource allocation time line 470 based on contents of the IO proposed plan list 210 added to the plan store 410 (S401-3). The resource allocation time line 470 is a table showing a type, a rate and an allocation period of a resource necessary to be allocated in adopting each proposed plan. Contents of reflection from the IO proposed plan stored in the plan store 410 in the resource allocation time line 470 are created using, for example, the resource performance table 430 and the resource correspondence table 450 as follows.

First, the IO plan reconfiguration function 401 identifies a resource to be used from the server identifier 419, and the Vol. identifier 420. Although the present embodiment assumes a case where as in the case of the resource correspondence table 450, a combination of the IO condition 451 which is a combination of server and Vol. and the resource 452 to be used is explicitly indicated in advance by the IO execution function 330 and the resource management function 340, the combination may be inquired with the IO execution function 330 and the resource management function 340 every time the resource allocation time line 470 is updated.

Next, the IO plan reconfiguration function 401 searches the combination of the determined resource 452 to be used and the resource IO pattern 421 from the performance table 430 and obtains maximum performance of processing capability of each resource. Regarding extraction of the maximum performance using the performance table 430, information may be explicitly shown in advance as in the case of the resource correspondence table 450 or dynamically inquired.

The resource 452 to be used obtained in this way and the ratio of the value of the IO bandwidth 422 to the maximum performance of the resource 452 to be used are stored in the resource 476 and the allocation rate 477 in the resource allocation time line respectively. At this time, in such a case where performance required for each resource corresponds to total performance multiplied by a certain coefficient for a reason that, for example, a multipath configuration using a plurality of ports is adopted, the allocation rate 477 may also be multiplied by a similar coefficient based on the description, for example, in the resource correspondence table 450. While in the present embodiment, the resource allocation time line is created based on resources necessary to process the IO request itself, for example, data to be a process target of an IO request may be planned to be stored in the cache area 321 in advance, data already existing in the cache area 321 may be planned to be saved and the resource allocation time line 470 may also be created for this.

Next, the IO plan reconfiguration function 401 creates a proposed combination plan from a proposed plan in the plan store 410 (S401-4). The proposed combination plan is obtained in principle by selecting one IO proposed plan from a plurality of IO proposed plans included in the IO proposed plan list 210 transmitted from each request source and combining the selected IO proposed plans. Depending on the combination of selected IO proposed plans, there are a plurality of proposed combination plans. However, when the establishment flag 415 is set in several proposed plans, the IO plan reconfiguration function 401 selects the IO proposed plan in which the establishment flag 415 is set from the IO proposed plan list 210 and excludes other proposed plans included in the same IO proposed plan list 210 from among combination candidates. Proposed IO plans in which the allocation rate 477 of any one resource exceeds 100% or a certain value such as 90% in the resource allocation time line 470 may be excluded.

For the proposed combination plan created in this way, the reserved resource table 600 is created (S401-5). The reserved resource table 600 shows a total of resources necessary to be reserved when an IO proposed plan included in the proposed combination plan is executed and a plurality of the reserved resource tables 600 are created for each combination plan. The IO plan reconfiguration function 401 enumerates the resource 476 of the resource allocation time line 470 corresponding to the IO proposed plan included in the proposed combination plan in the resource 603 of the reserved resource table 600, sums up the allocation rates 477 corresponding to the respective resources and stores the total in the utilization rate 605. However, in this case, if a plurality of resource allocation time lines having identical target identifiers 473 are included, instead of simply summing up, a resource allocation time line, an allocation rate of which becomes maximum is selected for each time or resource among the resource allocation time lines having the same target identifiers 473, the allocation rate thereof is calculated and then summed up with other resource allocation time lines. This is intended to avoid multiplexed reservation of resources for the same target.

Next, the resource allocation evaluation function 403 evaluates the reserved resource table 600 created for each combination of plan proposals (S401-6). In an evaluation by the resource allocation evaluation function 403, an allocation penalty value in the case where a utilization rate of a resource r at a certain time point t is a(t, r) is calculated according to the following equation.

∫ₜΣᵣw(r)a(t,r)^{k}

Here, w(r) is a weight of each resource and k is a depletion penalty index. For example, w(r) is manually or automatically configured by taking into account the frequency with which each resource is required and k is configured to be a relatively high value when the utilization rate is heavily biased or a relatively low value equal to or larger than 1 when the utilization rate is less biased depending on the bias in the past resource utilization rate.

The IO plan reconfiguration function 401 selects a combination with the best evaluation (here, one with the smallest allocation penalty value) using the evaluation result for each combination of proposed plans calculated in this way (S401-7). Here, the combination with the best evaluation refers to a combination with the highest utilization efficiency of resources of the storage 300. Regarding the IO proposed plan included in the combination, an adoption flag 414 of the plan store 410 is configured. When the adoption flag 414 is configured, the IO proposed plan is provisionally selected and if the response time limit 413 is reached before the next IO plan reconfiguration is executed, the selection is established. Furthermore, when the resource management function 340 of the storage 300 has a function of restricting the amount of resources used, the function may be requested to restrict the amount of resources used based on the resource allocation time line 470 and contents of the reserved resource table 600 (S401-8).

When the selected IO proposed plan is executed in this way, by obtaining a combination of IO proposed plans so as to optimize the utilization rate of the storage 300 and selecting the IO proposed plan, it is possible to avoid contention of resources, which cannot be reserved by a single server 100, among the servers 100, efficiently use resources of the storage 300 and ensure performance.

The IO arbitration function 400 repeats the aforementioned steps S401-1 to S401-8 every time an IO proposed plan list 210 is received and reviews whether or not to adopt each IO proposed plan for a non-established, that is, an IO proposed plan without any establishment flag every time a new IO proposed plan list 210 is received.

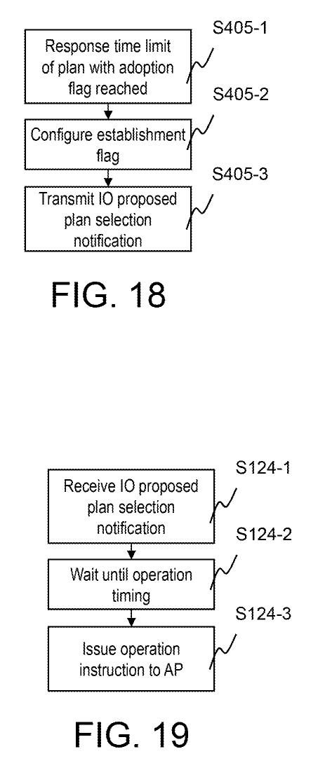

FIG. 18 is a diagram illustrating a flowchart of a process of establishing an IO proposed plan to be selected from a plurality of IO proposed plans transmitted with the IO proposed plan list 210 and notifying the server 100 of the IO proposed plan. This corresponds to detailed description of the process of IO plan establishment (S6) and selection result notification (S7) in FIG. 3.

The IO plan establishment function 405 performs an establishment process on the IO plan according to the response time limit 413. First, the IO plan establishment function 405 detects which IO proposed plan reaches its response time limit through periodic scanning of the plan store 410 or timer activation or the like and starts operation (S405-1). At this time, the establishment flag 415 is configured in the IO proposed plan in which the adoption flag 414 is configured among the IO proposed plans in the IO proposed plan list 210 in the plan store 410, time limits of which are reached (S405-2). In this way, the selection of the IO proposed plan in which the establishment flag 415 is configured is established. The IO plan establishment function 405 transmits an IO proposed plan selection notification to the process plan function 120 of the server 100 (S405-3). The IO proposed plan selection notification includes a plan proposal identifier 611 to identify the IO proposed plan, the selection of which is established in S405-2. The IO proposed plan selection notification may respond as to whether or not to adopt each IO proposed plan included in the IO proposed plan list 210. The process plan function 120 performs a process in accordance with contents of an IO proposed plan selection notification 610 through the operation instruction function 124.

In this way, without establishing the adopted IO proposed plan until the response time limit 413, reconfigureing the IO proposed plan every time the IO proposed plan list 210 is received makes it possible to select an optimum combination from the plurality of IO proposed plan lists 210 transmitted from the plurality of servers 100 and efficiently and effectively use resources of the storage 300. Note that the IO plan selected after reconfiguration of the IO proposed plan may be immediately established and the selection result may be notified to the process plan function 120.

FIG. 19 is a diagram illustrating a flowchart of a process for the process plan function 120 that receives the IO proposed plan selection notification to instruct the application 112 to execute a process based on the notified selection result. This corresponds to detailed description of the process of the operation instruction (S8) in FIG. 3.

When the selection result reception function 125 receives the IO proposed plan selection notification 610, the operation instruction function 124 starts operation (S124-1). The operation instruction function 124 compares the proposed plan table 130 with a plan proposed identifier 611 described in the IO proposed plan selection notification, identifies the selected plan proposal and performs a process corresponding to the selected proposed plan. More specifically, when the description contents of the proposed plan table 130 show that the application 112 performs a specific operation at a specific time point, the operation instruction function 124 waits until the timing (S124-2). For example, when the proposed plan 1 is adopted and the proposed plan 1 describes that a snapshot is executed at 11:00, the operation instruction function 124 waits without giving any instruction on the execution to the application 112 until 11:00. When the described time point is reached, the operation instruction function 124 issues an operation instruction to the application 112 (S124-3). In the present embodiment, an instruction on a snapshot operation or an instruction on suspension of operation is given to the application 112. Instead of giving an instruction on suspension of operation, giving no instruction may be adopted as an alternative.

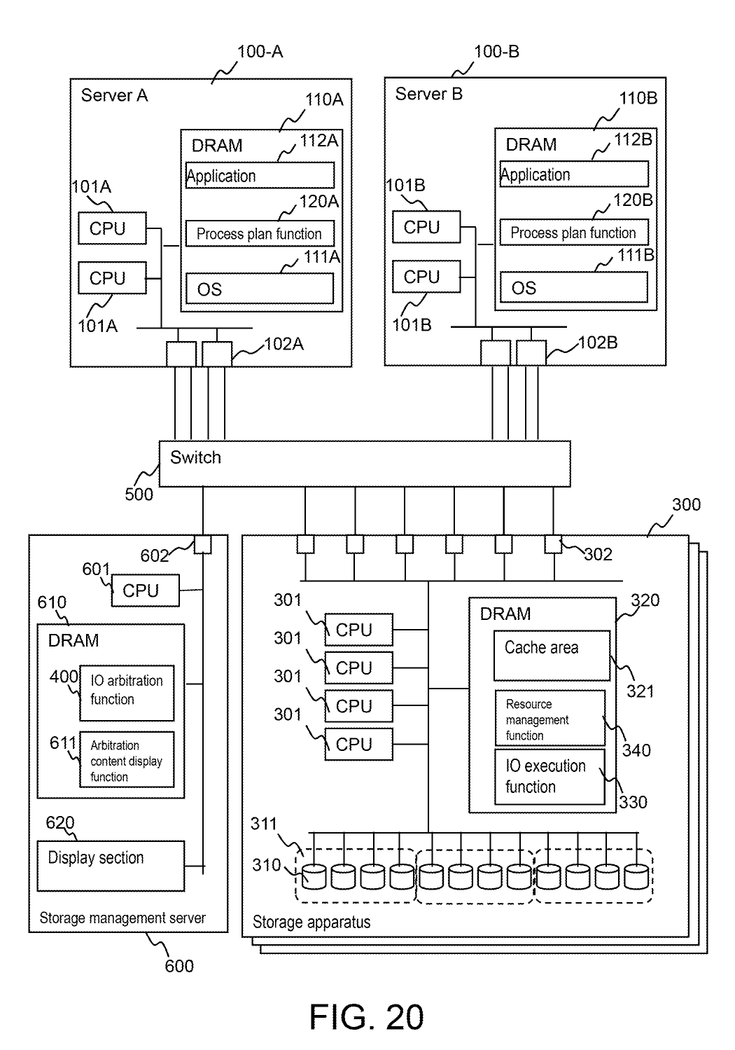

A case has been described so far where the present invention is implemented to achieve an SLO of a failover time. Note that the IO arbitration function 400 exists in the storage 300 according to the present invention, but as shown in FIG. 20, for example, a storage management server 600 which is different from the storage 300 may exist in the system and this may be provided with the IO arbitration function 400. Furthermore, at this time, a plurality of storage apparatuses 300 may exist, or as resources, not only resources in the storage apparatus but also resources in the switch 500, a bus between the server 100 and the storage 300 or a network may be an arbitration target. In this case, the server 100 transmits the IO proposed plan list 210 to the storage management server 600 and receives an IO proposed plan selection notification from the storage management server 600.

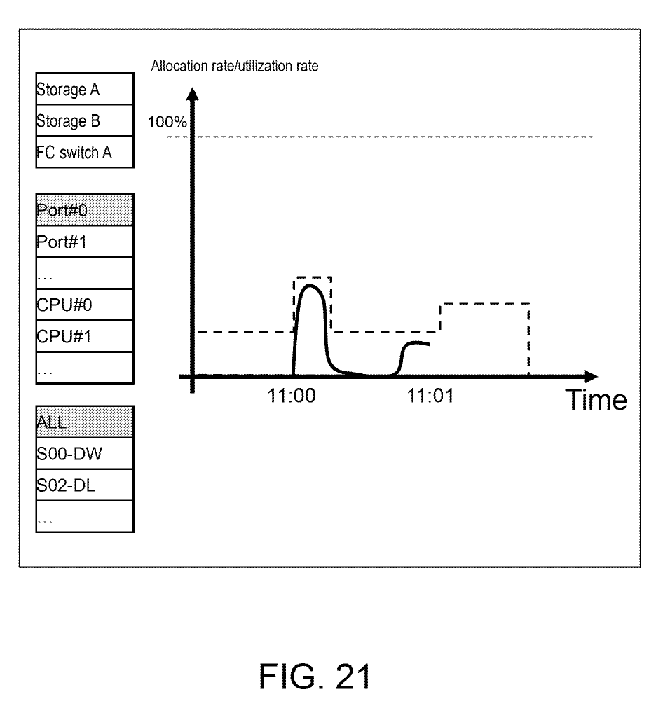

The storage management server 600 may be provided with an arbitration content display function 611 to confirm the validity of arbitration contents, and as shown, for example, in FIG. 21, may display a utilization rate of each resource according to the plan selected by arbitration and resources actually used. The arbitration content display function 611 may also be provided with a function of displaying a whole or part of the plan store 410, the resource allocation time line 470 and the reserved resource table 600 and their change histories.

The present embodiment has adopted a scheme in which the process plan function 120 creates a plurality of IO proposed plans and the IO arbitration function 400 selects a proposed plan from among the plans, but a scheme may be adopted in which the plan proposed function 120 creates one IO proposed plan and the IO arbitration function 400 determines whether or not to execute the IO proposed plan. In this case, as for the resource situation and IO arbitration function of the storage 300, one or a plurality of executable IO proposed plans are selected from among the IO proposed plans transmitted from another server 100 and the result is notified to the process plan function 120.

### REFERENCE SIGNS LIST

100 Application server
120 Process plan function
300 Storage apparatus
400 IO arbitration function

1. A system comprising:
a computer comprising a memory configured to store a program and a first CPU (central processing unit) configured to execute the program; and
a storage apparatus comprising a drive coupled to the computer to store data and a second CPU configured to control storage of data in the drive according to an IO (input/output) request issued by the program, wherein
the first CPU is configured to transmit an IO proposed plan which is information on the IO request to be issued by the program to the storage apparatus,
the second CPU is configured to determine to adopt the IO proposed plan based on a resource utilization rate of the storage apparatus when the process of the IO request to be issued is executed and transmit a notification indicating the adopted IO proposed plan to the computer, and
the first CPU is configured to issue an IO request relating to the IO proposed plan based on the notification.

2. The system according to claim 1, wherein
the first CPU is configured to transmit a plurality of the IO proposed plans as an IO proposed plan list to the storage apparatus, and
the second CPU is configured to select the IO proposed plan adopted from the IO proposed plan list.

3. The system according to claim 2, wherein
a response time limit is configured in the IO proposed plan list,
the second CPU is configured to select, upon receiving the first IO proposed plan list, the IO proposed plan to be adopted from a first IO proposed plan list,
reselect, after receiving the first IO proposed plan list and upon receiving a second IO proposed plan list before the response time limit of the first IO proposed plan list, the IO proposed plan to be adopted from the first IO proposed plan list, select the IO proposed plan to be adopted from the second IO proposed plan list, and
transmit, when the response time limit of the first IO proposed plan list is reached, a notification indicating adoption of the selected IO proposed plan among the IO proposed plans included in the first IO proposed plan list to the computer.

4. The system according to claim 2, wherein
the IO proposed plan comprises information on resources of the storage apparatus necessary to process the IO request to be issued,
the first CPU is configured to calculate resources of the storage apparatus necessary to process the IO request to be issued based on an operation situation of the program, configuration information of the program and information on the resources used by the program.

5. The system according to claim 4, wherein
the IO proposed plan list comprises a first IO proposed plan and a second IO proposed plan,
the first IO proposed plan is a plan configured to reserve resources of the storage apparatus necessary to process a first data write request and resources of the storage apparatus necessary to process a data read request for recovery from a failure, and
the second IO proposed plan is a plan configured to reserve resources of the storage apparatus necessary to process a data read request for recovery from a failure without issuing any write request of the first data.

6. The system according to claim 5, wherein
the configuration information comprises information on an SLO (service level objective),
the first CPU is configured to record a log of processes executed by the program, and
calculate resources of the storage apparatus necessary to process a data read request for recovery from a failure so that the sum of a time required to reapply the process recorded in the log to the read data and a time required to read data for recovery from the failure does not exceed the SLO.

7. A method for control of a system, the system comprising:
a computer comprising a memory configured to store a program and a first CPU (central processing unit) configured to execute the program; and
a storage apparatus comprising a drive coupled to the computer to store data and a second CPU configured to control storage of data in the drive according to an IO (input/output) request issued by the program, the method comprising:
creating an IO proposed plan which is information on an IO request to be issued by the program in the storage apparatus;
determining to adopt the IO proposed plan based on a resource utilization rate of the storage apparatus when the process of the IO request to be issued is executed; and
issuing an IO request associated with the IO proposed plan based on the determination.

8. The method for control of a system according to claim 7, wherein an IO proposed plan list comprising a plurality of the IO proposed plans are created and the IO proposed plan to be adopted is adopted and selected from the IO proposed plan list.

9. The method for control of a system according to claim 8, wherein
a response time limit is configured in the IO proposed plan list,
when a first IO proposed plan list is received, the IO proposed plan to be adopted is selected from the first IO proposed plan list,
after the first IO proposed plan list is received, if a second IO proposed plan list is received before the response time limit of the first IO proposed plan list, the IO proposed plan to be adopted is reselected from the first IO proposed plan list and the IO proposed plan to be adopted is selected from the second IO proposed plan list, and
when the response time limit of the first IO proposed plan list is reached, a notification indicating an adoption of the selected IO proposed plan among the IO proposed plans included in the first IO proposed plan list is sent to the computer.

10. The method for control of a system according to claim 8, wherein
the IO proposed plan comprises information on resources of the storage apparatus necessary to process the IO request to be issued, and
the resources of the storage apparatus necessary to process the IO request to be issued are calculated based on an operation situation of the program, configuration information of the program and information on resources used by the program.

11. The method for control of a system according to claim 10, wherein
the IO proposed plan list comprises a first IO proposed plan and a second IO proposed plan,
the first IO proposed plan is a plan configured to reserve resources of the storage apparatus necessary to process a first data write request and resources of the storage apparatus necessary to process a data read request for recovery from a failure, and
the second IO proposed plan is a plan configured to reserve resources of the storage apparatus necessary to process a data read request for recovery from a failure without issuing the first data write request.

12. The method for control of a system according to claim 11, wherein
the configuration information comprises information on an SLO (service level objective),
the computer is configured to record a log of a process executed by the program, and
calculate resources of the storage apparatus necessary to process a data read request for recovery from a failure so that the sum of a time required to reapply the process recorded in the log to the read data and a time required to read data for recovery from the failure does not exceed the SLO.
